(19) United States
(12) Patent Application Publication
(10) Pub. No.: US 2026/0080239 A1
(43) Pub. Date: Mar. 19, 2026

(54) UTILIZING A COMPOUND-PERTURBATION ANOMALY DETECTION MODEL TO IDENTIFY OUTLIER COMPOUND-PERTURBATION RELATIONSHIPS

(71) Applicant: Recursion Pharmaceuticals, Inc., Salt Lake City, UT (US)

(72) Inventors: Benjamin Marc Feder FOGELSON, Salt Lake City, UT (US); Brittney Mae VIERRA, Salt Lake City, UT (US); Jacob Carter COOPER, Sandy, UT (US); Lu CHEN, Farmington, UT (US); Marissa Gerda SAUNDERS, Salt Lake City, UT (US); Michael Frank CUCCARESE, Salt Lake City, UT (US); Murat OZTURK, Toronto (CA); Rebecca SARTO BASSO, North Hollywood, CA (US); Vivek JAYAN, Dublin, CA (US)

(21) Appl. No.: 18/887,587

(22) Filed: Sep. 17, 2024

(51) Int. Cl. G06N 3/08

(52) U.S. Cl. CPC G06N 3/08

(57) ABSTRACT

The present disclosure relates to systems, non-transitory computer-readable media, and methods that identifies outlier gene-compound relationships by leveraging a trained machine learning classification model and a compound-perturbation anomaly detection model. Indeed, in one or more implementations, the disclosed systems generate a plurality of compound-perturbation interaction predictions by using a machine learning classification model trained using a plurality of compound-perturbation features. For instance, the disclosed systems select a set of target features from the plurality of compound-perturbation features based on contribution values of the compound-perturbation features in generating the compound-perturbation interaction predictions. In some instances, the disclosed systems train a compound-perturbation anomaly detection model to identify outlier compound-perturbation relationships from the set of target features.

### BACKGROUND

Recent years have seen significant developments in hardware and software platforms that utilize computational models to identify relationships between genes and compounds. For example, conventional systems utilize computing devices to parse through large volumes of gene-compound data to identify potential relationships. Despite recent advancements, conventional systems continue to experience a variety of technical problems, including accuracy, efficiency, and operational flexibility of implementing computing devices in discovering gene-compound relationships.

### SUMMARY

Embodiments of the present disclosure provide benefits and/or solve one or more of the foregoing or other problems in the art with systems, non-transitory computer-readable media, and methods for utilizing a two-stage framework for identifying outlier compound-perturbation relationships utilizing a machine learning classification model and a compound-perturbation anomaly detection model. For example, in one or more implementations, the first stage involves the disclosed systems selecting sets of target features using a machine learning classification model. Specifically, the disclosed systems can train a machine learning classification model with a plurality of compound-perturbation features to generate a plurality of compound-perturbation interaction predictions. Once trained, the disclosed systems can utilize the machine learning classification model in conjunction with an explainability model to select a set of target features from the plurality of compound-perturbation features that are used to generate the plurality of compound-perturbation interaction predictions. Furthermore, the disclosed systems can utilize the set of target features to then build a compound-perturbation anomaly detection model to identify outlier-gene compound relationships.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an overview diagram of a compound-perturbation anomaly detection model identifying outlier compound-perturbation relationship(s) in accordance with one or more embodiments.

FIG. 2 illustrates an example diagram of the compound-perturbation anomaly detection system training a machine learning classification model in accordance with one or more embodiments.

FIG. 3 illustrates an example diagram of the compound-perturbation anomaly detection system using a rolling window of interaction measures as a gene-compound feature in accordance with one or more embodiments.

FIG. 4 illustrates an example diagram of the compound-perturbation anomaly detection system selecting a set of target features based on contribution values in accordance with one or more embodiments.

FIGS. 5A-5B illustrates an example diagram of the compound-perturbation anomaly detection system generating multi-dimensional distributions using a probabilistic anomaly detection model in accordance with one or more embodiments.

FIG. 6 illustrates an example diagram of the compound-perturbation anomaly detection system using a trained unsupervised gene-compound anomaly detection model to generate an anomaly score (or compound activity score) in accordance with one or more embodiments.

FIG. 7 illustrates an example environment of the compound-perturbation anomaly detection system in accordance with one or more embodiments.

FIG. 8 illustrates an example series of acts to identify outlier compound-perturbation relations in accordance with one or more embodiments.

FIG. 9 illustrates a block diagram of a computing device for implementing one or more embodiments.

### DETAILED DESCRIPTION

Embodiments of the present disclosure provide benefits and/or solve one or more of the foregoing or other problems in the art with systems, non-transitory computer-readable media, and methods of a compound-perturbation anomaly detection system that identifies outlier compound-perturbation relationships utilizing a machine learning classification model and a compound-perturbation anomaly detection model. Specifically, the compound-perturbation anomaly detection system optimizes various models for identifying and synthesizing unique, novel data signals to predict anomalous compound-perturbation relationships (e.g., gene-compound relationships). For example, the compound-perturbation anomaly detection system implements a two-stage framework to prime a pipeline for detecting compound-perturbation outliers (e.g., gene-compound outliers). For instance, the first stage involves feature selection/engineering using a classification machine learning model and feature ranking (e.g., using an explainability model). Moreover, the second stage involves training an unsupervised anomaly/outlier detection model per perturbation (e.g., gene) using the features selected from the first stage. Upon building a compound-perturbation anomaly detection model (such as a gene-compound anomaly detection model), in one or more implementations, the compound-perturbation anomaly detection system can respond to queries and generate outlier compound-perturbation relationship predictions (even where the compound-perturbation anomaly detection system does not have data related to interactions between a query compound and a query perturbation (e.g., a query gene and a query compound).

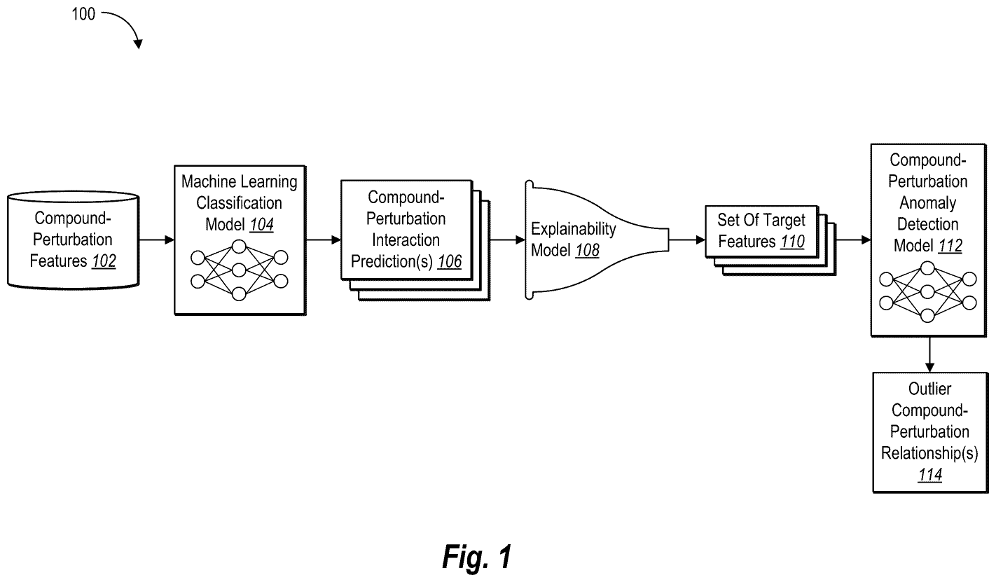

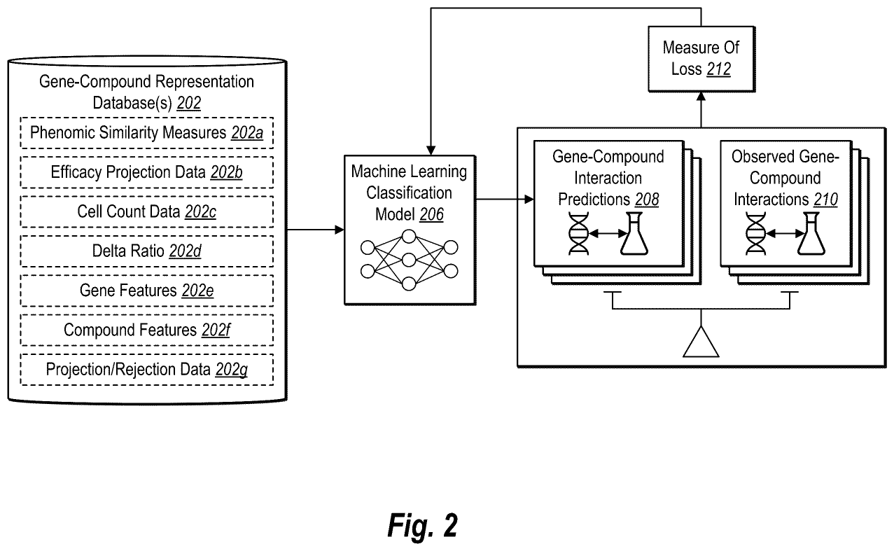

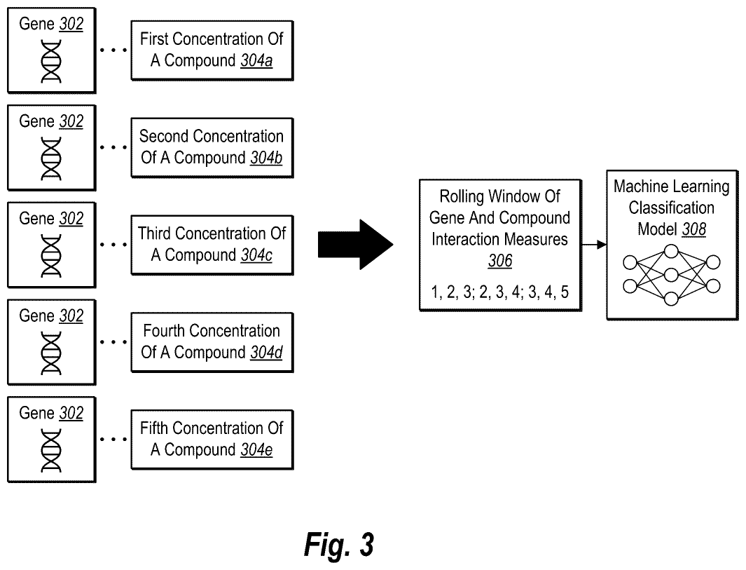

FIG. 1 illustrates an overview of a compound-perturbation anomaly detection system 100 performing both stages of a two-stage framework for determining outlier compound-perturbation relationships (e.g., gene-compound relationships) in accordance with one or more embodiments. As shown, in the first stage the compound-perturbation anomaly detection system 100 trains a machine learning classification model 104 to predict gene-compound interactions utilizing compound-perturbation features 102 developed from a database of compound-perturbation interactions (e.g., such as gene-compound interactions). For example, the compound-perturbation anomaly detection system 100 can utilize gene-compound features (e.g., a subset of compound-perturbation features) such as phenomic similarity measures, area under the curve, and/or rolling windows to capture digital signals regarding a compound at multiple concentrations interacting with a gene (as discussed in more detail below in FIGS. 2 and 3). The compound-perturbation anomaly detection system 100 can then utilize observed compound-perturbation interactions from known chemical entities as ground truths to train this classification machine learning model (as discussed in more detail below in FIG. 2).

As shown, the compound-perturbation anomaly detection system 100 receives the compound-perturbation features 102. As used herein, a compound refers to a molecule (e.g., a substance comprising two or more elements chemically bonded together). A compound can include a pharmaceutical or therapeutic compound (e.g., a small molecule drug). As used herein, a perturbation refers to a modification or treatment applied to a cell. For example, in some implementations, the compound-perturbation anomaly detection system 100 applies a perturbation to a cell, such as a CRISPR gene knockout, a pharmaceutical/therapeutic compound, or a biologic (e.g., large compound, such as a protein, antibody, or nucleic acid). Thus, a perturbation can include a gene, small molecule, biologic, or other treatment.

The compound-perturbation features can include features of a compound, features of a perturbation (e.g., a gene corresponding to a gene knockout perturbation or another perturbation), and/or interactions between the compound and the perturbation. Thus, for example, “compound-perturbation features” includes features of a compound, a protein, an anti-body, a gene, an enzyme, a receptor, or RNA, and further includes a metric reflecting an interaction or relationship between compounds and other perturbations (e.g., a compound-compound interaction, a compound-protein interaction, a compound-anti-body interaction, a compound-gene interaction, a compound-enzyme interaction, a compound-receptor interaction, a compound-RNA interaction, etc.). As just mentioned, the compound-perturbation features 102 can include gene-compound features. As used herein, the term “gene-compound features” refers to features of a gene or a compound and further includes features that capture or reflect an interaction or relationship between genes and compounds. Specifically, the gene-compound features include a bio-chemical representation of genes and compounds such as phenomic similarity measures, efficacy projection data, cell count data, delta ratios, projection/rejection data, or similarity metrics from other computer-implemented models/algorithms, which are discussed in more detail below in FIG. 2.

Furthermore, as shown, the compound-perturbation anomaly detection system 100 uses the machine learning classification model 104 to process the compound-perturbation features 102. As used herein, the term “machine learning classification model” refers to a model trained to generate classification predictions (such as the compound-perturbation interaction prediction(s) 106 based on compound-perturbation features such as gene-compound features). Specifically, the compound-perturbation anomaly detection system 100 trains the machine learning classification model 104 by using the model to generate compound-perturbation interaction prediction(s) 106 using the compound-perturbation features 102. The compound-perturbation anomaly detection system 100 can utilize a variety of machine learning classification models, including decision trees, support vector machines, or neural networks (e.g., deep neural networks/convolutional neural networks).

In one or more embodiments, the compound-perturbation anomaly detection system 100 utilizes a light gradient boosting machine (e.g., LightGBM) as the machine learning classification model 206. For instance, the compound-perturbation anomaly detection system 100 trains the LightGBM to build an ensemble of decision tress where each new tree is trained to correct the errors from previous trees.

Moreover, as shown, the compound-perturbation anomaly detection system 100 uses the machine learning classification model 104 to generate the compound-perturbation interaction prediction(s) 106. As used herein, the term “compound-perturbation interaction prediction(s)” includes a prediction of a relationship or interaction between a gene and a compound, a compound and a protein, and a compound and an anti-body. Specifically, as used herein a “gene-compound interaction prediction(s)” refer to a prediction of a relationship or interaction between a gene and a compound (e.g., generated during training of the classification model based on the gene-compound features). Specifically, the gene-compound interaction prediction(s) indicate a prediction as to whether a gene and a compound have a relationship (e.g., does a compound have a similar impact as a gene or directly impact expression of a gene). Moreover, the compound-perturbation anomaly detection system 100 can use the gene-compound interaction prediction(s) to compare it against ground truth(s) and modify parameters of the machine learning classification model 104.

For instance, in some embodiments, the gene-compound interaction prediction(s) include a binary classification of whether there is an interaction between a compound and a perturbation, specifically, whether there is an interaction between a gene and a compound (e.g., there is an interaction/relationship or there is not an interaction/relationship). In some embodiments, the compound-perturbation anomaly detection system 100 uses the machine learning classification model 104 to generate a classification score and further references a classification threshold. If the classification score satisfies a threshold, then the compound-perturbation anomaly detection system 100 determines that there is an interaction between a compound and a perturbation (e.g., a gene and a compound).

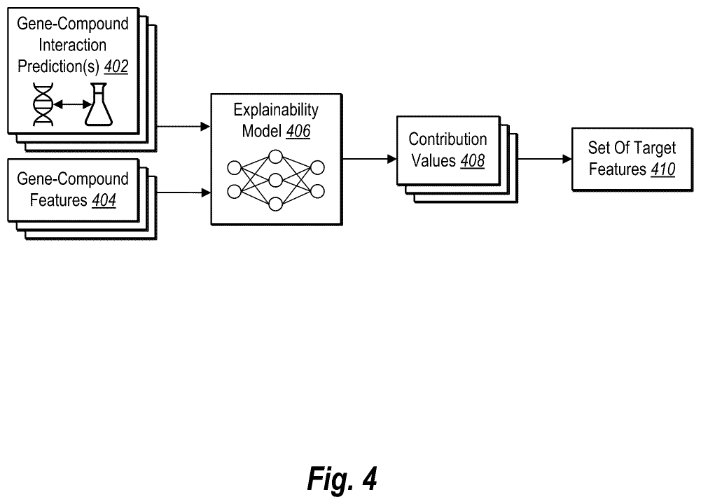

Moreover, FIG. 1 shows the compound-perturbation anomaly detection system 100 using an explainability model 108 to identify a set of target features. For instance, the compound-perturbation anomaly detection system 100 uses the explainability model 108 to identify those features from the compound-perturbation features 102 that most contributed to the compound-perturbation interaction prediction(s) 106. Additional details of the compound-perturbation anomaly detection system 100 using the explainability model 108 is provided below in the description of FIG. 4.

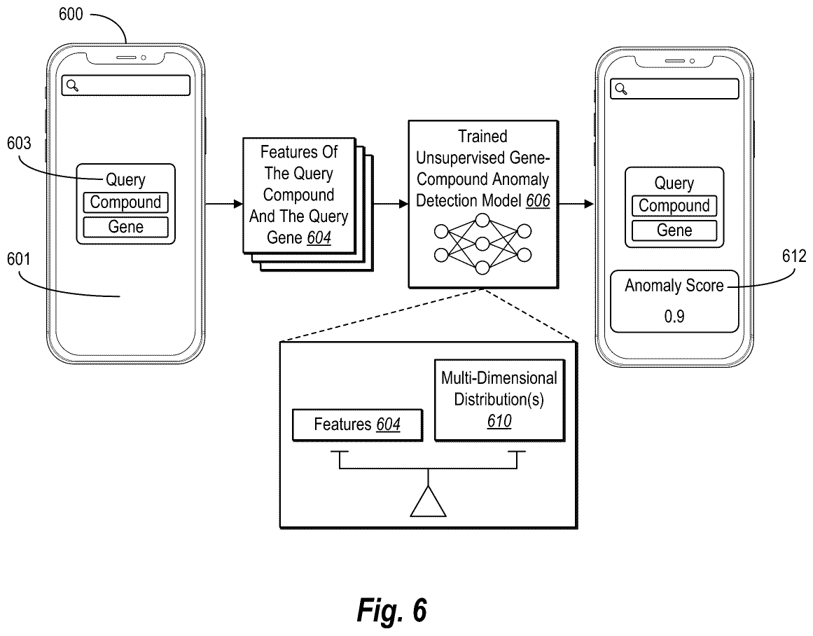

FIG. 1 further shows the compound-perturbation anomaly detection system 100 using a compound-perturbation anomaly detection model 112 to process a set of target features 110 (e.g., selected using the explainability model 108). Specifically, the compound-perturbation anomaly detection model 112 is trained to identify outlier compound-perturbation relationships utilizing one or more anomaly detection algorithms. For example, the compound-perturbation anomaly detection model 112 can utilize an unsupervised compound-perturbation anomaly detection model that utilizes clustering algorithms (e.g., K-means, DBSCAN, hierarchical cluster) or statistical algorithms (e.g., Gaussian mixture models) to identify outliers or anomalies in input features. A compound-perturbation anomaly detection model can include machine learning approaches, such as an isolation forest. For example, in some implementations, compound-perturbation anomaly detection system 100 builds multi-dimensional distributions. Further, the compound-perturbation anomaly detection system 100 compares incoming samples (e.g., gene-compound features for a queried gene and compound) against the built multi-dimensional distributions. Thus, the compound-perturbation anomaly detection system 100 can use the compound-perturbation anomaly detection model 112 to identify outliers (e.g., abnormal samples) of an incoming set of features from a query relative to expected multi-dimensional distributions. Additional details are given below in the description of FIG. 6.

As mentioned above, conventional systems suffer from a number of technical deficiencies that can be addressed by the compound-perturbation anomaly detection system 100. For example, conventional systems suffer from inaccuracy in identifying gene-compound relationships. Specifically, conventional systems typically rely on clinically observed data that indicates biological examples of treatments associated with diseases to identify such relationships. However, conventional systems relying on such observed data fails to accurately identify gene-compound relationships. For instance, conventional systems use clinically observed data to train anomaly detection models, but they suffer from overfitting to clinically observed data. In other words, conventional systems learn irrelevant or unimportant parts of clinically observed data (e.g., captures noise and random fluctuations in the observed data) which results in conventional systems performing poorly on unseen data. Thus, conventional systems fail to accurately identify gene-compound relationships, especially for unseen data domains.

In addition, conventional systems typically depend on the availability of clinically observed data for a specific disease to attempt to identify gene-compound relationships. For instance, conventional systems typically process a large volume of clinically observed data to attempt to identify specific relationships between genes and compounds (e.g., indicated by observed data) that may indicate unknown relationships. In conventional systems, however, it is difficult to identify relationships between genes and clinical outcomes because of the high dimensionality of observed data. As such, conventional systems fail to accurately identify novel relationships between genes and compounds due to the high-volume of data.

Furthermore, conventional systems suffer from inefficiencies in determining gene-compound relationships. Indeed, as mentioned, conventional systems typically require a large volume of clinically observed data. Conventional systems require significant resources to store, process, and analyze such data. For instance, conventional systems can take days or weeks to sort through gene-compound features and predict pertinent relationships. Even upon identifying certain relationships, the results of conventional systems are often inaccurate, as discussed above.

In addition to these accuracy and efficiency concerns, conventional systems also suffer from operational inflexibility. As mentioned above, conventional systems rigidly rely on observed data to identify certain anomalous relationships between genes and compounds. As discussed, this rigid approach undermines the ability of conventional systems to accurately discover gene-compound relationships across unseen data domains.

The compound-perturbation anomaly detection system 100 provides a variety of technical benefits and addresses technical problems of conventional systems. For example, the compound-perturbation anomaly detection system 100 can improve accuracy of implementing computing devices by utilizing a two-stage framework for discovering outlier gene-compound relationships. In contrast to conventional systems (e.g., which rely on clinically observed data and suffer from overfitting problems), the compound-perturbation anomaly detection system 100 trains the machine learning classification model 104 to intelligently select target features for an (unsupervised) anomaly detection model. Specifically, the compound-perturbation anomaly detection system 100 generates gene-compound interaction prediction(s) and utilizes the explainability model 108 to identify significant target features (e.g., the set of target feature 110) that contribute to the gene-compound interaction prediction(s). The compound-perturbation anomaly detection system 100 can then utilizes these features to build an accurate anomaly detection model for determining outlier gene-compound relationships. For example, the compound-perturbation anomaly detection system 100 can compare incoming sample data from a gene-compound query to multi-dimensional distributions of the anomaly detection model to identify the outlier compound-perturbation relationship(s) 114. Thus, the compound-perturbation anomaly detection system 100 can leverage analysis of the intelligently selected target features to accurately identify a compound and gene that have a new, previously unknown relationship.

In one or more implementations, the compound-perturbation anomaly detection system 100 selects the data in a biologically intelligent way and utilizes the compound-perturbation anomaly detection model 112 in an unsupervised manner (e.g., the compound-perturbation anomaly detection system 100 can leverage background data from the gene-compound features to identify anomalous relationships for unseen sample data) to more accurately identify outlier gene-compound relationships. Specifically, the compound-perturbation anomaly detection system 100 addresses the overfitting problem for anomalous relationship detection by first identifying the set of target features 110 that explain variance within observed data (e.g., explains the most predictability within the observed data). In other words, the compound-perturbation anomaly detection system 100 can identify data that is most suited for predicting broad gene-compound associations. Additionally, the compound-perturbation anomaly detection system 100 can then utilize the set of target features 110 in an unsupervised learning technique to discover anomalous interactions of compounds of interest with genes. For instance, the compound-perturbation anomaly detection system 100 establishes a set of parameters to reference (e.g., the multi-dimensional distributions) but the set of parameters are not strictly relied on in the outlier gene-compound relationship detection process, which decouples the compound-perturbation anomaly detection system 100 from the overfitting problem.

Moreover, in contrast to conventional systems (e.g., which typically struggle with accuracy due to having to collect a large volume of gene-compound interaction data), the gene-compound anomaly detection system does not need to rely on collecting specific data interactions to determine whether there is an anomalous relationship between a query gene and a query compound. Specifically, the gene-compound anomaly detection system can use existing background data for a wide variety of gene-compound interactions and generalize that background data to identify anomalous gene-compound relationships for unseen gene-compound interactions.

Furthermore, the gene-compound anomaly detection system can reduce the number of false positives for detecting anomalies for gene-compound relationships by establishing a probability threshold. Specifically, in some embodiments, the compound-perturbation anomaly detection system 100 can favor accuracy (e.g., reduce false positives while still having a good rate of true positives) to reduce the number of false positives by establishing a probability threshold of 0.9 for the anomaly score. By establishing a probability threshold of 0.9, the compound-perturbation anomaly detection system 100 can have a true positive to false positive recovery of about 16:1.

In addition to improving upon accuracy, the compound-perturbation anomaly detection system 100 can further improve upon efficiency of conventional systems. For example, the compound-perturbation anomaly detection system 100 can improve efficiency by generating compound-perturbation interaction prediction(s) 106 and identifying the most significant features (e.g., the set of target features 110) to use for creating an unsupervised learning technique for identifying anomalous relationships. In contrast to conventional systems which consume excessive time and resources to parse through clinically observed data, the compound-perturbation anomaly detection system 100 efficiently narrows down a large data set to gene-compound features to specific target features for building an anomaly detection model. In other words, the compound-perturbation anomaly detection system 100 can prepare a drug discovery pipeline for efficiently detecting outlier gene-compound relationships in an efficient and accurate manner. This approach can significantly reduce time and computer resources in identifying outlier gene-compound relationships.

In addition, the compound-perturbation anomaly detection system 100 can more efficiently present information to a client device in a graphical user interface. Rather than multiple interfaces and shuffling between multiple different data sources, the compound-perturbation anomaly detection system 100 streamlines all the information into a single interface. Specifically, the gene-compound anomaly detection system provides an interface for a client device to send one or more query compounds and one or more query genes. From the client device sending a query, the compound-perturbation anomaly detection system 100 can generate an anomaly score for a specific gene-compound interaction and present the anomaly score to the client device.

Related to the accuracy and efficiency improvements, the compound-perturbation anomaly detection system 100 can further improve upon operational flexibility of conventional systems. In contrast to conventional systems which rigidly rely on observed data, in one or more implementations, the compound-perturbation anomaly detection system 100 flexibly draws from observed data to create an unsupervised learning framework for identifying outlier gene-compound relationships in an efficient and accurate manner. This more flexible approach allows implementing computing devices to also perform outlier identification tasks previously unavailable to conventional systems.

As mentioned above, the compound-perturbation anomaly detection system 100 can train and utilize a machine learning classification model to determine a set of target features. FIG. 2 illustrates the compound-perturbation anomaly detection system 100 training the machine learning classification model by comparing gene-compound interaction predictions with observed gene-compound interactions in accordance with one or more embodiments.

As shown in FIG. 2, the compound-perturbation anomaly detection system 100 receives gene-compound features from gene-compound representation database(s) 202. Specifically, the gene-compound representation database(s) 202 can include phenomic similarity measures 202a, efficacy projection data 202b, cell count data 202c, delta ratio 202d, various additional gene-compound features (e.g., gene features 202e and compound features 202f), and projection/rejection data 202g. As mentioned previously, in some implementations, the compound-perturbation anomaly detection system 100 can utilize similarity measures from other computer-implemented models, such as predictions from a molecular foundation model used to predict chemical and biological properties from molecular graphs or a structure-phenomics relationship model that predicts relationships with other perturbations from an input compound structural feature representation. For instance, the gene-compound representation database(s) 202 accessed by the compound-perturbation anomaly detection system 100 can include a combination of known chemical entities (i.e., a substance with a defined chemical composition and structure that has been identified and characterized through scientific study) and novel chemical entities (a newly discovered or synthesized chemical compound that has not been previously identified or characterized in scientific literature).

As just mentioned, the gene-compound representation database(s) 202 include phenomic similarity measures 202a. For instance, the compound-perturbation anomaly detection system 100 generates the phenomic similarity measures 202a from imaging perturbation embeddings applied to cells. As used herein, the term “cell” refers to a structural, functional, and biological unit of living organisms. Specifically, a cell can vary in size, shape, and function depending on the organism and the role of the cell. For example, a cell can include a plasma membrane to separate the internal cell environment from the external surroundings and the cell can further contain genetic material.

As used herein, the term “perturbation” (e.g., cell perturbation) refers to an alteration or disruption to a cell or the cell's environment (to elicit potential phenotypic changes to the cell). In particular, the term perturbation can include a gene perturbation (i.e., a gene-knockout perturbation) or a compound perturbation (e.g., a molecule perturbation or a soluble factor perturbation). These perturbations are accomplished by performing a perturbation experiment. A perturbation experiment refers to a process for a perturbation to a cell. A perturbation experiment also includes a process for developing/growing the perturbed cell into a resulting phenotype.

As used herein, the term perturbation images (or phenomic digital images), refers to a digital image portraying a cell (e.g., a cell after applying a perturbation). For example, a perturbation image includes a digital image of a stem cell after application of a perturbation and further development of the cell. Thus, a perturbation image comprises pixels that portray a modified cell phenotype resulting from a particular cell perturbation. In one or more embodiments, the compound-perturbation anomaly detection system 100 embeds the perturbation images into a low dimensional feature space via a machine learning model (e.g., a convolutional neural network or generative model such as a masked autoencoder neural network) to generate perturbation image embeddings. Thus, a perturbation embedding includes a feature vector generated by application of various neural network layers (at different resolutions/dimensionality).

As used herein, the term “perturbation embedding” (or perturbation embeddings, individual perturbation image embeddings or phenomic image embeddings) refers to a numerical representation of a perturbation image resulting from a perturbation to a cell. For example, a perturbation embedding includes a vector representation of a perturbation image generated by a machine learning model (e.g., a convolutional neural network or other machine learning embedding model). Thus, a perturbation embedding includes a feature vector generated by application of convolutional various neural network layers (at different resolutions/dimensionality). Thus, the compound-perturbation anomaly detection system 100 can create a perturbation embedding (e.g., by applying a compound to target a specific gene) and compare the perturbation embeddings to an embedding of a gene (e.g., without a perturbation) to determine a level of similarity (e.g., an effect that the perturbation has on targeting one or more genes).

In one or more embodiments, the compound-perturbation anomaly detection system 100 determines a phenomic similarity measure by imaging a cell with a gene knockout perturbation for a target gene and generating an embedding of the image of the cell. Similarly, the compound-perturbation anomaly detection system 100 images an additional cell with a compound perturbation and generates an embedding of the image of the additional. The compound-perturbation anomaly detection system 100 then compares these two embedding. For example, the compound-perturbation anomaly detection system 100 compares the perturbation embedding (e.g., the cell with the gene knockout) with the compound embedding (e.g., the cell with the compound applied to it) to determine phenomic similarities (e.g., an overlap in phenomic characteristics, such as whether the compound applied to the cell has a similar effect to a target gene as directly knocking out the target gene). For instance, the compound-perturbation anomaly detection system 100 determines a distance or a cosine similarity between the different embeddings.

In one or more embodiments, the compound-perturbation anomaly detection system 100 determines a distance between embeddings by measuring a straight-line distance between the two embeddings in a latent space. Thus, the shorter the distance between the two embeddings, the greater the phenomic similarity measure. In some embodiments, the compound-perturbation anomaly detection system 100 determines a cosine similarity between the two embeddings by measuring a cosine of the angle between the two embeddings. Thus, the greater the cosine similarity, the greater the phenomic similarity measure.

To illustrate, the compound-perturbation anomaly detection system 100 utilizes the methods described in application Ser. No. 18/526,707 (UTILIZING MACHINE LEARNING MODELS TO SYNTHESIZE PERTURBATION DATA TO GENERATE PERTURBATION HEATMAP GRAPHICAL USER INTERFACES), filed on Dec. 1, 2023, to generate phenomic similarity measures for perturbation embeddings, which is fully incorporated by reference herein. Further, the compound-perturbation anomaly detection system 100 utilizes the methods described in application Ser. No. 18/392,989 (UTILIZING MACHINE LEARNING AND DIGITAL EMBEDDING PROCESSES TO GENERATE DIGITAL MAPS OF BIOLOGY AND USER INTERFACES FOR EVALUATING MAP EFFICACY), filed on Dec. 21, 2023, to generate phenomic similarity measures for perturbation embeddings, which is fully incorporated by reference herein.

As further shown, the gene-compound representation database(s) 202 further contains the efficacy projection data 202b. As used herein, “efficacy projection data” refers to a prediction regarding how effective a compound is in modulating the activity of specific target genes. In other words, the efficacy projection data 202b predicts the therapeutic or inhibitory effects of compounds on genes. Specifically, the compound-perturbation anomaly detection system 100 can generate or access the efficacy projection data 202b from dose-response experiments, which includes treating target cells with various concentrations of a compound and measuring the response of the target genes. For example, the compound-perturbation anomaly detection system 100 can determine the expression levels and activity of genes from being treated with various concentrations of a compound (e.g., to determine the efficacy projection data 202b of a gene being treated with a compound).

For example, the compound-perturbation anomaly detection system 100 generates the efficacy projection data 202b by matching a dose-response curve to increasing concentrations of a compound dose as compared to a vector representation of the gene knockout. For instance, the compound-perturbation anomaly detection system 100 generates a representation (e.g., an embedding vector) of a target gene and further generates a plurality of representations (e.g., embedding vectors) of a compound at increasing doses. The compound-perturbation anomaly detection system 100 compares these representations (e.g., using cosine similarity) to determine a measure of response for each compound. The compound-perturbation anomaly detection system 100 can fit a dose-response curve based on the measures of response between the gene representation and the compound representations at different doses.

Furthermore, in some implementations, the compound-perturbation anomaly detection system 100 derives metrics from the dose-response curve such as the max efficacy (e.g., the efficacy projection data 202b) and predicted EC₅₀ (e.g., half maximal effective concentration that measures efficacy of a concentration of a compound that produces 50% of its maximum effect to gage the potency of a compound in activating a biological response).

In one or more embodiments, the compound-perturbation anomaly detection system 100 can utilize an area under the curve metric for data that is concentration (or other variable) dependent (e.g., has a different response for a different dose of a compound). For instance, the compound-perturbation anomaly detection system 100 maps a concentration of a compound on an x-axis and maps a response variable on the y-axis. Further, the compound-perturbation anomaly detection system 100 can determine a window of area under the curve with respect to a particular concentration range. For instance, the compound-perturbation anomaly detection system 100 can use an area under the curve metric for the efficacy projection data 202b and the phenomic similarity measures 202a.

In one or more embodiments, the compound-perturbation anomaly detection system 100 generates a phenomic similarity measure by comparing a gene embedding (e.g., an embedding of an image of a cell with a gene knockout) with a compound embedding at a first dose (e.g., an embedding of an image of a cell exposed to a first dose of a compound). Further, the compound-perturbation anomaly detection system 100 takes another phenomic similarity measure by comparing the gene embedding with another compound embedding at a second dose. Thus, the compound-perturbation anomaly detection system 100 can determine the phenomic similarity measures for a cell with a target compound applied at multiple doses and create a dose-response curve for the target compound at multiple doses. Accordingly, the compound-perturbation anomaly detection system 100 can determine the area under the curve for the dose-response curve of the phenomic similarity measures of a target compound. Thus, the compound-perturbation anomaly detection system 100 utilizes the area under the curve for the phenomic similarity measures 202a as a feature for the machine learning classification model 206.

In one or more embodiments, the compound-perturbation anomaly detection system 100 can determine an area under the curve for the efficacy projection data 202b. In one or more embodiments, the compound-perturbation anomaly detection system 100 can determine an area under the curve for the efficacy projection data 202b. Specifically, the compound-perturbation anomaly detection system 100 can determine the area under a dose-response curve (e.g., various doses of a compound applied to a target gene), where the area under the dose-response curve represents the overall efficacy of a compound targeting a gene across different concentrations. In some embodiments, the compound-perturbation anomaly detection system 100 can determine the area under the curve as a statistical metric used to measure effectiveness of a compound targeting a gene over time. Specifically, the area under the curve helps the compound-perturbation anomaly detection system 100 compare different compounds and determine optimal doses of a compound in targeting a gene.

As mentioned, the compound-perturbation anomaly detection system 100 processes the cell count data 202c. As used herein, the term “cell count data” refers to a quantitative measurement of the number of cells in a sample after treatment with a compound. Specifically, the cell count data can indicate cell proliferation (e.g., an increase), cell death (e.g., a decrease), or cell viability (percentage of living cells). For example, the compound-perturbation anomaly detection system 100 applies a compound or other perturbation batches of cells and determines different cell counts. Specifically, the compound-perturbation anomaly detection system 100 measures a difference of cell count for a representation of a compound applied to a set of cells and a gene knockout representation for another set of cells. For instance, the cell count data indicates whether a compound inhibits, promotes, or changes the viability of a cell (e.g., by a compound targeting a specific gene). In other words, the difference in cell count can indicate whether there is a related function between the compound and the gene knockout.

Moreover, as shown, the compound-perturbation anomaly detection system 100 processes the delta ratio 202d. As used herein, the term “delta ratio” refers to a measure of similarity between a target compound and a gene relative to other measured similarities between the target compound and other genes. In other words, the delta ratio 202d refers to a measure of interaction between a target compound and a gene in relation to how other genes interacts with the target compound (or vice versa). For instance, the delta ratio 202d adds context to how strong a gene-compound interaction is relative to the other genes. Thus, the delta ratio 202d can indicate where a program gene ranks relative to other genes. In some implementations, the compound-perturbation anomaly detection system 100 can generate a delta ratio that indicates a measure of similarity between a compound and a gene relative to other measures of similarity between the gene and other compounds.

To illustrate, the compound-perturbation anomaly detection system 100 can determine a phenomic similarity measure between a first gene and a first compound as 0.95. However, by leveraging the delta ratio, the compound-perturbation anomaly detection system 100 can determine the phenomic similarity measure of the first gene and the first compound relative to other genes. For instance, the compound-perturbation anomaly detection system 100 can determine the phenomic similarity measure of the first compound and a second gene, a phenomic similarity measure of the first compound and a third gene, and a phenomic similarity measure of the first compound and a fourth gene. Specifically, if the other phenomic similarity measures indicate measures higher than 0.95, then the compound-perturbation anomaly detection system 100 can determine that the delta ratio indicates that the phenomic similarity measure between the first gene and the first compound is not as significant of a factor. The delta ratio can include a ranking (relative to other relationships), a ranking percentage, or a ratio/comparison of the similarity measures.

As shown, the compound-perturbation anomaly detection system 100 can also generate and utilize projection/rejection data 202g. As used herein, the term projection/rejection data refers to data relating to a direction and magnitude comparison of perturbations in a feature space. In other words, the projection/rejection data 202g includes a direction and magnitude between two embeddings. In particular, the projection/rejection data 202g includes a location of a reference embedding and a direction and magnitude of other embeddings relative to the reference embedding. In some implementations, the compound-perturbation anomaly detection system 100 projects perturbations onto a target perturbation and determines a magnitude and direction of other perturbations (e.g., relative to the target perturbation). Thus, the compound-perturbation anomaly detection system 100 can utilize the projection/rejection data 202g as a feature of a gene-compound interaction to generate gene-compound interaction predictions.

As mentioned, additional gene-compound features can include predicted similarity measures from other computer-implemented models or algorithms. For example, in some implementations, the compound-perturbation anomaly detection system 100 can utilize “Mol-E,” a molecular foundation model for drug discovery that utilizes machine learning tools to predict chemical and biological properties directly from molecular graph representations. To illustrate, the compound-perturbation anomaly detection system 100 utilizes the methods described in Oscar Mendez-Lucio, Christos Nicolaou, and Berton Earnshaw, MolE: a molecular foundation model for drug discovery, arXiv: 2211.02657v1, Nov. 3, 2022, which is fully incorporated by reference herein.

Similarly, in some implementations, the compound-perturbation anomaly detection system 100 utilizes a “Sphere” model, which includes structure-phenomics relationship model for predicting relationships between an input compound other perturbations (e.g., other compounds or genes). For example, the compound-perturbation anomaly detection system 100 can utilize the Sphere model to take an input compound and predict whether the compound will have a threshold similarity to a particular gene or set of query genes (or to a particular compound or set of compounds). After training the Sphere model, the compound-perturbation anomaly detection system 100 can utilize the Sphere model to analyze structural features of input compounds and generate a predicted similarity class for other perturbations. For example, the compound-perturbation anomaly detection system 100 can utilize the Sphere model to predict whether a query compound will be pheno-similar, unrelated to, or pheno-opposite to one or more genes (or other perturbations, such as other compounds). To illustrate, the compound-perturbation anomaly detection system 100 utilizes the methods described in application Ser. No. 18/753,906 (DETERMINING PHENOMIC RELATIONSHIPS BETWEEN COMPOUNDS AND CELL PERTURBATIONS UTILIZING MACHINE LEARNING MODELS) filed on Jun. 25, 2024, to generate the Sphere data, which is fully incorporated by reference herein.

As shown in FIG. 2, the compound-perturbation anomaly detection system 100 processes the above-discussed gene-compound features from the gene-compound representation database(s) 202. In some embodiments, the compound-perturbation anomaly detection system 100 extracts the gene-compound features from various data sources (e.g., third-party or internal data sources). For instance, the compound-perturbation anomaly detection system 100 receives gene-compound features from the gene-compound representation database(s) 202 for a specific gene and uses a machine learning classification model 206 to generate a prediction for that specific gene relative to one or more compounds.

As shown, the compound-perturbation anomaly detection system 100 generates gene-compound interaction predictions 208 which indicate whether or not a gene has a relationship with a compound. As mentioned above, the gene-compound interaction predictions 208 can be binary and in some embodiments, the gene-compound interaction predictions 208 can include a classification score (e.g., 0.68). For instance, if the gene-compound interaction predictions 208 include a score, the compound-perturbation anomaly detection system 100 can establish a classification score threshold. If the gene-compound interaction predictions 208 satisfies the classification score threshold (e.g., >0.70), then the compound-perturbation anomaly detection system 100 can indicate that the gene and compound have a relationship.

As also shown in FIG. 2, the compound-perturbation anomaly detection system 100 can compare the gene-compound interaction predictions 208 with observed gene-compound interactions 210. As used herein, the term “observed gene-compound interaction” refers to a ground truth measure of whether a gene and compound interact. Specifically, the compound-perturbation anomaly detection system 100 uses the observed gene-compound interactions 210 to train the machine learning classification model 206. For example, based on past experimental data and scientific literature, the compound-perturbation anomaly detection system 100 accesses observed gene-compound interactions.

As shown in FIG. 2, based on the comparison of the gene-compound interaction predictions 208 with the observed gene-compound interactions 210, the compound-perturbation anomaly detection system 100 determines a measure of loss 212. As used herein, the term “a measure of loss” refers to a loss function which the compound-perturbation anomaly detection system 100 attempts to minimize. In other words, for a gene-compound interaction prediction, the compound-perturbation anomaly detection system 100 minimizes the distance for a gene-compound prediction that is close in similarity to an observed gene-compound interaction and maximizes the distance for gene-compound prediction that is not close in similarity to an observed gene-compound interaction. Furthermore, as shown, the compound-perturbation anomaly detection system 100 modifies parameters of the machine learning classification model 206 based on the measure of loss 212.

Although FIG. 2 illustrates a gene-compound representation database(s) 202, in one or more embodiments, the compound-perturbation anomaly detection system 100 can use any number of databases. Specifically, the compound-perturbation anomaly detection system 100 can utilize a compound-protein database, a compound-anti-body database, a compound-enzyme database, a compound-receptor database, and a compound-RNA database.

As mentioned above, the compound-perturbation anomaly detection system 100 can utilize rolling windows of interaction measures as a gene-compound feature for training a machine learning classification model. FIG. 3 illustrates the compound-perturbation anomaly detection system 100 receiving data indicating interaction measures corresponding to a compound at different doses. Moreover, the compound-perturbation anomaly detection system 100 determines a rolling window of interaction measures between the gene and the compound in accordance with one or more embodiments.

For example, FIG. 3 shows that based on a plurality of cell-based assays (e.g., sets of cells are perturbed with different concentrations of a compound), the compound-perturbation anomaly detection system 100 can determine a first measure of interaction between a gene 302 and a first concentration 304a of a compound, a second measure of interaction of the gene 302 with a second concentration 304b of the compound, a third measure of interaction of the gene 302 with a third concentration 304c of the compound, a fourth measure of interaction of the gene 302 with a fourth concentration 304d of the compound, and fifth measure of interaction of the gene 302 with a fifth concentration 304e of the compound. For each of the concentrations for the gene 302, the compound-perturbation anomaly detection system 100 can determine a measure of interaction between the gene and the compound. Thus, the compound-perturbation anomaly detection system 100 can determine a rolling window of the interactions across different concentrations.

As used herein, “a measure of interaction” refers to a metric indicating a gene-compound interaction/relationship (e.g., at a specified concentration/dose of a compound). Specifically, the compound-perturbation anomaly detection system 100 can apply different doses/concentrations of a compound to a cell or a set of cells and measure the strength, magnitude, or extent of a relationship/interaction between the compound and a gene. For example, the compound-perturbation anomaly detection system 100 determines measures of interaction (e.g., cell count, phenomic similarity measure, efficacy projection data, delta ratio, etc.) between genes and compounds at different concentrations of a compound and utilizes various statistical measures (e.g., rolling window or area under the curve) to utilizes as a gene-compound feature.

To illustrate, the compound-perturbation anomaly detection system 100 can take cells with five different concentrations for a compound applied to the cells and determine a specific type of interaction measure (e.g., phenomic similarity) relative to a gene for each concentration. The compound-perturbation anomaly detection system 100 can also determine a rolling window 306 of the measure of interaction. As used herein, the term “rolling window” refers to a moving average/metric for gene-compound features. Specifically, the rolling window refers to a statistical method to analyze gene-compound feature data at different concentrations of a compound. For instance, the compound-perturbation anomaly detection system 100 can use five concentrations of a compound with three rolling windows. To illustrate, for five concentrations, the three rolling windows can include the first concentration 304a, the second concentration 304b, and the third concentration 304c (e.g., 1, 2, 3); the second concentration 304b, the third concentration 304c, and the fourth concentration 304d (e.g., 2, 3, 4); and the third concentration 304c, the fourth concentration 304d, and the fifth concentration 304e (e.g., 3, 4, 5). Moreover, in some embodiments, the compound-perturbation anomaly detection system 100 can combine values from each window (e.g., take an average of the rolling windows or sum the rolling windows). For example, in some implementations, the compound-perturbation anomaly detection system 100 can take the max value for each of the windows to obtain three aggregated interaction measures. In some implementations, the compound-perturbation anomaly detection system 100 can combine the values in each window using a different approach (e.g., the average, sum, or minimum).

In one or more embodiments, the compound-perturbation anomaly detection system 100 can determine the rolling window of a gene by performing an integral of a specific concentration range (e.g., a dose-response curve) to determine the area under the curve and divide the area under the curve by the length of the range. Specifically, the compound-perturbation anomaly detection system 100 can use a trapezoidal mean to divide an interval ([a, b]) into smaller subintervals, approximate an area under the curve by forming a trapezoid for each subinterval, and summing the areas of the trapezoids to determine an approximation of the total area under the curve.

As shown, the compound-perturbation anomaly detection system 100 feeds as input the rolling window 306 to a machine learning classification model 308. In particular, as discussed above, the compound-perturbation anomaly detection system 100 uses the rolling window 306 as a gene-compound feature and generates a gene-compound interaction prediction based on the rolling window 306. Thus, the compound-perturbation anomaly detection system 100 can generate a gene-compound interaction prediction based on the rolling window 306 and/or additional gene-compound features.

As mentioned above, in one or more embodiments, the compound-perturbation anomaly detection system 100 can further utilize the area under the curve metric (e.g., for various gene-compound interaction measures) as a gene-compound feature for the machine learning classification model 308 to generate a gene-compound interaction prediction. As discussed above, for a gene-compound feature, the compound-perturbation anomaly detection system 100 can utilize a model to plot data for a specific interaction measure between a gene and a compound and determine an area under the curve of the specific interaction measure. Specifically, the compound-perturbation anomaly detection system 100 can area under the curve metric as a specific feature to determine whether a gene and a compound have a relationship.

In one or more embodiments, the compound-perturbation anomaly detection system 100 uses a threshold number of concentrations (e.g., less than or equal to 5) for a compound at a threshold dose (e.g., greater than a predefined amount of a compound). In some embodiments, using a threshold number of concentrations at a threshold dose as the gene-compound features helps the compound-perturbation anomaly detection system 100 generate more consistent results (e.g., anomaly scores). In other words, a higher dose of a concentration helps the compound-perturbation anomaly detection system 100 avoid detecting anomalies in lower concentration doses where they may not exist.

As also mentioned above, the compound-perturbation anomaly detection system 100 uses an explainability model to filter down gene-compound features to a set of target features. FIG. 4 illustrates the compound-perturbation anomaly detection system 100 determining contribution values of gene-compound features to further identify the most significant features that contribute to a gene-compound interaction prediction.

As shown in FIG. 4, the compound-perturbation anomaly detection system 100 processes gene-compound interaction prediction(s) 402 and gene-compound features 404 using an explainability model 406. As used herein, the term “explainability model” refers to a framework to understand contribution of various features for a (predicted) outcome. In other words, the compound-perturbation anomaly detection system 100 utilizes the explainability model 406 to determine to what degree or extent genes-compound features contribute to the machine learning classification model generating gene-compound interaction predictions.

Specifically, the compound-perturbation anomaly detection system 100 utilizes the explainability model 406 to generate contribution values 408 for gene-compound features from a plurality of gene-compound interaction predictions of the machine learning classification model. For example, the compound-perturbation anomaly detection system 100 can use the explainability model 406 to assign contributions to each input feature to the machine learning classification model based on its impact on the output (e.g., the gene-compound interaction prediction) by considering interactions between features. Moreover, the compound-perturbation anomaly detection system 100 generates or identifies a set of target features 410 based on the contribution values 408.

For example, the compound-perturbation anomaly detection system 100 can use the explainability model 406 to assign contributions to each input feature of the machine learning classification model based on its impact on the output (e.g., the gene-compound interaction prediction) by considering interactions between features (e.g., to identify the set of target features 410). As used herein, the term “set of target features” refers to gene-compound features that were most important (e.g., relative to the other gene-compound features) in generating a gene-compound interaction prediction.

In some embodiments, the compound-perturbation anomaly detection system 100 utilizes the machine learning classification model and the explainability model 406 to perform univariate feature selection (e.g., select gene-compound features that have the strongest relationship with the gene-compound interaction predictions). The compound-perturbation anomaly detection system 100 can utilize a variety of explainability models, such as SHAP, LIME, Partial Dependent Plots, Feature Importance, or Counterfactual Explanations. For instance, the compound-perturbation anomaly detection system 100 utilizes an explainability model 406, such as SHAP (Shapley Additive Explanations), to determine the gene-compound features that contribute most significantly to the gene-compound interaction prediction(s) 402. For example, the compound-perturbation anomaly detection system 100 utilizes SHAP to quantify the contribution of a gene-compound feature to a particular gene-compound interaction prediction. Specifically, SHAP is based on cooperative game theory and provides a way to distribute a total gain/loss of a game fairly among players (e.g., gene-compound features) based on their contributions. To determine the contribution values, the compound-perturbation anomaly detection system 100 can compute the marginal contribution of each gene-compound feature by considering all possible subsets of features (e.g., the difference in a model's prediction with and without the gene-compound feature is calculated). In other words, the compound-perturbation anomaly detection system 100 can permute, perturb, or modify the input features to generate the gene-compound interaction prediction(s) 402 and compute the marginal contribution of the input features by measuring the variations in the gene-compound interaction prediction(s) 402 relative to the perturbations in the input features. Thus, a contribution value for a gene-compound feature is a measure (e.g., the average) of its marginal contributions across permutations of gene-compound feature subsets.

In one or more embodiments, the compound-perturbation anomaly detection system 100 further generates a ranked list of features. Specifically, the compound-perturbation anomaly detection system 100 selects the set of target features 410 and ranks the target features according to impactfulness (e.g., relative to the other features). In other words, the compound-perturbation anomaly detection system 100 uses the contribution values 408 of the gene-compound features 404 to determine which of the gene-compound features 404 contributed the most to the generated gene-compound interaction prediction, in order from most impactful to least impactful (e.g., generates a ranked list of features).

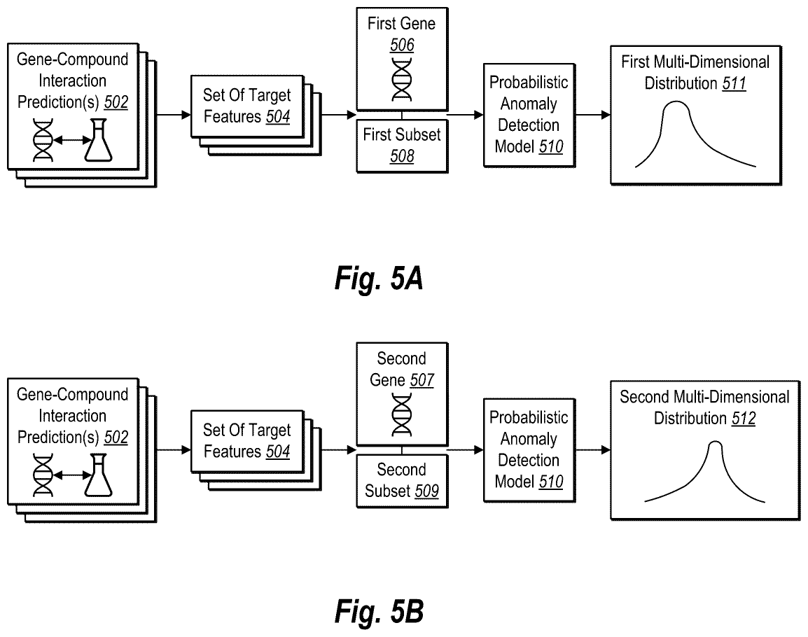

As mentioned above, the compound-perturbation anomaly detection system 100 can utilize an anomaly detection model to generate multi-dimensional distributions. FIGS. 5A-5B illustrate an example diagram of the compound-perturbation anomaly detection system 100 utilizing the gene-compound anomaly detection model to generate multi-dimensional distributions corresponding to different genes in accordance with one or more embodiments. For example, FIG. 5A shows the compound-perturbation anomaly detection system 100 receiving gene-compound interaction prediction(s) 502. As discussed above, the compound-perturbation anomaly detection system 100 identifies a set of target features 504 that most contributed to the gene-compound interaction prediction(s) 502 using an explainability model.

As shown in FIG. 5A, the compound-perturbation anomaly detection system 100 further filters down a set of target features 504 for a first gene 506. Specifically, the compound-perturbation anomaly detection system 100 identifies from the set of target features 504, a first subset 508 of features that corresponds to the first gene 506. Specifically, the compound-perturbation anomaly detection system 100 identifies features from the set of target features 504 such as phenomic similarity measures for the first gene 506 (e.g., a similarity of an embedding of the first gene with compound X), projection/rejection data for the first gene 506, cell count data for the first gene 506, and the delta ratio for the first gene 506. Additional features corresponding to other genes are not included in the first subset 508.

For instance, the compound-perturbation anomaly detection system 100 identifies the first subset 508 to generate expected probability distributions of significant gene-compound features specific to the first gene 506. In particular, as shown, the compound-perturbation anomaly detection system 100 utilizes a probabilistic anomaly detection model 510 to generate a first multi-dimensional distribution 511 from the first subset 508 of features corresponding to the first gene 506 (e.g., for a specific feature of the first gene 506, such as phenomic similarity measures).

As shown in FIG. 5B, the compound-perturbation anomaly detection system 100 filters down the set of target features 504 to a second subset 509 of the set of target features 504 that corresponds to a second gene 507. As mentioned above, the compound-perturbation anomaly detection system 100 can identify the features that correspond to the gene of interest. Specifically, FIG. 5B illustrates the compound-perturbation anomaly detection system 100 identifying features of the set of target features 504 that correspond to the second gene 507, such as identifying features not included in the first subset 508 that also correspond with the second gene 507. For instance, the compound-perturbation anomaly detection system 100 can identify features such as phenomic similarity measures for the second gene 507, the cell count data for the second gene 507, and the delta ratio for the second gene 507.

Similar to FIG. 5A, the compound-perturbation anomaly detection system 100 identifies the second subset 509 to generate expected probability distributions of significant gene-compound features specific to the second gene 507. In particular, as shown, the compound-perturbation anomaly detection system 100 utilizes the probabilistic anomaly detection model 510 to generate a second multi-dimensional distribution 512 for the second gene 507.

As used herein, the term “probabilistic anomaly detection model” refers to a statistical algorithm to model complex data distributions for gene-compound features and to further identify outliers based on the modeled data distributions. Specifically, the compound-perturbation anomaly detection system 100 can use the probabilistic anomaly detection model 510 that includes a Gaussian Mixture Model or an isolation forest model.

As used herein, the term “multi-dimensional distribution” refers to a statistical distribution of a set of target features (e.g., for a gene). For example, a multi-dimensional distribution includes to a mixture of Gaussians for various features (e.g., gene-compound features corresponding to a gene). In one or more embodiments, a gaussian mixture model refers to a probabilistic anomaly detection model that accounts for data generated from various Gaussian distributions (e.g., individual Gaussian (normal) distributions). For instance, each Gaussian distribution can capture a distinct subpopulation within the identified data (e.g., the target set of features corresponding to a specific gene). By combining multiple Gaussian components, a Gaussian Mixture Model can model complex, multimodal distributions (e.g., that includes multiple features for the gene).

To illustrate, the compound-perturbation anomaly detection system 100 uses a Gaussian Mixture Model to statistically combine a target set of gene-compound interactions. For instance, a specific gene can include a set of target features such as the projection/rejection data, efficacy projection data, the delta ratio, and the phenomic similarity measures. From the set of target features, the compound-perturbation anomaly detection system 100 can utilize the Gaussian Mixture Model to determine a number of Gaussian components (K) to fit (e.g., using methods such as Bayesian Information Criterion and/or Akaike Information Criterion) to balance model complexity and goodness of fit. In particular, the compound-perturbation anomaly detection system 100 uses one of the just-mentioned methods to fit the Gaussian Mixture Model to the data (e.g., the set of target features for a specific gene) and iteratively estimates the parameters of the data (e.g., the mean, covariance, and mixing coefficients) for each Gaussian component. In some embodiments, the compound-perturbation anomaly detection system 100 can utilize a Gaussian Mixture Model to determine a first Gaussian component (e.g., for data first feature such as phenomic similarity measures), a second Gaussian component (e.g., a second feature such as delta ratio), and a third Gaussian component for (data third feature such as cell count data). Thus, using the Gaussian Mixture Model, the compound-perturbation anomaly detection system 100 combines the first Gaussian component, the second Gaussian component, and the third Gaussian component to form a multi-dimensional distribution for a gene.

At run-time (e.g., when receiving a gene-compound query), the compound-perturbation anomaly detection system 100 can compare sample data (e.g., a set of target features corresponding to a gene-compound query) to a multi-dimensional distribution (e.g., to identify a gene-compound interaction anomaly). In other words, the compound-perturbation anomaly detection system 100 can compare incoming samples (e.g., data of a query compound for a query gene) against the multi-dimensional distribution (e.g., generated by the anomaly detection model containing multiple features to compare against) to determine how abnormal the values of the incoming samples are relative to the expected distributions. Thus, as shown, the compound-perturbation anomaly detection system 100 can utilize the Gaussian Mixture Model to generate a first multi-dimensional distribution 511 for a first gene and/or the second multi-dimensional distribution 512 for a second gene.

Moreover, the compound-perturbation anomaly detection system 100 can utilize the probabilistic anomaly detection model 510 that includes an isolation forest model. For instance, the compound-perturbation anomaly detection system 100 can utilize the isolation forest model to isolate observations by randomly selecting a feature (e.g., from the set of target features corresponding to a specific gene) and then randomly selecting a split value (e.g. a threshold used to divide a dataset into two subsets based on a specific feature) between maximum and minimum values of the selected feature. In other words, the compound-perturbation anomaly detection system 100 can utilize the isolation forest model to randomly select a feature (e.g., efficacy projection data) for a gene interacting with various different compounds, and then determine a split value to divide the dataset into maximum and minimum values. Further, the compound-perturbation anomaly detection system 100 iteratively repeats the process of random selection and split values to create a tree structure where data points that are easily isolated (e.g., outliers) tend to have shorter paths (between a root and a leaf node) in the tree. Thus, the compound-perturbation anomaly detection system 100 can utilize the isolation forest model to create the first multi-dimensional distribution 511 and/or the second multi-dimensional distribution 512.

In one or more embodiments, a multi-dimensional distribution includes the set of target features 504 that correspond to a specific gene (e.g., the set of target features identified using a machine learning classification model and explainability model). Indeed, as discussed previously, the compound-perturbation anomaly detection system 100 can utilize a machine learning classification model to generate a set of gene-compound interaction predictions for a first gene and multiple different compounds. As discussed previously, the compound-perturbation anomaly detection system 100 generates a prediction of whether a first compound, a second compound, a third compound, a fourth compound, and a fifth compound interact with a first gene. From these predictions (utilizing an explainability model), the compound-perturbation anomaly detection system 100 further identifies the most significant features (e.g., the set of target features 504) that contributed to each of the predictions. Moreover, in instances where the set of target features 504 include additional data that corresponds to other genes (e.g., a second gene), the compound-perturbation anomaly detection system 100 filters down the set of target features 504 to target features that only correspond to the first gene.

For instance, the compound-perturbation anomaly detection system 100 can determine that the target features (e.g., the ones that most contributed to predictions of gene-compound interactions for a first gene) include phenomic similarity measures, projection data, cell count data, and delta ratio data. For these target features, the compound-perturbation anomaly detection system 100 can generate a first multi-dimensional distribution (for a first gene) using the Gaussian Mixture Model or the Isolation Forest Model. Thus, the compound-perturbation anomaly detection system 100 generates a multi-dimensional distribution that covers the set of target features 504 for a specific gene and compares incoming sample data against the multi-dimensional distribution for a specific gene to determine how abnormal the incoming sample data values are relative to the expected multi-dimensional distribution.

As mentioned above, at implementation time, the compound-perturbation anomaly detection system 100 identifies outlier gene-compound relationships in response to a query. FIG. 6 illustrates an example diagram of the compound-perturbation anomaly detection system 100 generating an anomaly score for a gene-compound query in accordance with one or more embodiments. For example, FIG. 6 shows a client device 600 with a graphical user interface 601, and the client device 600 submitting a query 603.

As illustrated in FIG. 6, the compound-perturbation anomaly detection system 100 receives a query from the client device 600 (e.g., that indicates a query compound and a query gene). In other words, the query 603 includes a request for the compound-perturbation anomaly detection system 100 to determine whether a significant interaction/relationship exists between the query gene and the query compound (e.g., whether the interaction between the query gene and the query compound is an anomaly relative to unrelated gene/compound interactions). In one or more embodiments, the query 603 can include a list of genes, and the query compound can also include a list of compounds. In other words, the compound-perturbation anomaly detection system 100 can receive a plurality of genes and a plurality of compounds as part of the query 603.

By way of example, the query 603 includes a first query gene (e.g., BRCA1) and a first query compound (e.g., compound X). For instance, the client device 600 submits a query to ascertain whether there is an anomalous relationship between BRCA1 and compound X. Moreover, the compound-perturbation anomaly detection system 100 can process the query 603 to determine features for additional analysis by an anomaly detection model (e.g., the trained unsupervised gene-compound anomaly detection model 606)

As shown in FIG. 6, based on the query 603 (e.g., that includes at least one query gene and one query compound), the compound-perturbation anomaly detection system 100 identifies features 604 of the query compound (compound X) and the query gene (BRCA1). In particular, as described above, the compound-perturbation anomaly detection system 100 previously utilized a machine learning classification model to select a set of target features. Thus, upon receiving the query 603 with the query compound and the query gene, the compound-perturbation anomaly detection system 100 identifies the features 604 (e.g., available features from the set of target features) that correspond to the query 603 to further determine whether an interaction between BRCA1 and compound X is anomalous. In other words, the compound-perturbation anomaly detection system 100 extracts features for the query compound and the query gene based on the target features identified utilizing the classification model and explainability model discussed above.

As shown in FIG. 6, the compound-perturbation anomaly detection system 100 accesses the features 604 for the query 603 of the query gene and the query compound. As alluded to, the features 604 can include one or more of the features described above (e.g., phenomic similarity measures, efficacy projection data, cell count data, delta ratio, various gene/compound features).

To illustrate, the compound-perturbation anomaly detection system 100 identifies the features 604 for the query compound X as 1) a particular phenomic similarity measure of 0.71 (e.g., for compound X interacting with BRCA1), 2) a particular cell count, and 4) a predicted similarity measure from a Mol-E model.

To determine whether the features 604 for the query gene and the query compound are anomalous, the compound-perturbation anomaly detection system 100 leverages a trained unsupervised gene-compound anomaly detection model 606. Specifically, the compound-perturbation anomaly detection system 100 utilizes the trained unsupervised gene-compound anomaly detection model 606 to compare the features 604 with a multi-dimensional distribution (e.g., the multi-dimensional distributions described above in FIGS. 5A-5B) that corresponds to a specific gene (e.g., BRCA1).

For instance, the compound-perturbation anomaly detection system 100 compares the phenomic similarity measures of compound X with a multi-dimensional distribution of BRCA1 that includes multiple features, such as phenomic similarity measures. Specifically, the gene-compound anomaly detection system compares whether the phenomic similarity measures of compound X (e.g., as indicated by the features 604) are abnormal compared to the expected distribution of phenomic similarity measures for BRCA1 in a multi-dimensional distribution for gene BRCA1. Moreover, the compound-perturbation anomaly detection system 100 further compares the additional features of compound X with each of the expected distributions in the multi-dimensional distribution for gene BRCA1.

As shown, the compound-perturbation anomaly detection system 100 compares the features 604 with the multi-dimensional distribution(s) 610 based on the compound-perturbation anomaly detection system 100 defining an anomaly for each multi-dimensional distribution. Specifically, the compound-perturbation anomaly detection system 100 can define a threshold for a multi-dimensional distribution as mean+/−k standard deviations, where k is a chosen constant. Data points outside of the established anomaly threshold is considered an anomaly. In some embodiments, the compound-perturbation anomaly detection system 100 can use a probability density function. Specifically, a probability density function involves the compound-perturbation anomaly detection system 100 calculating the probability for observing a given feature under a normal distribution. If the probability is below a certain threshold, the given feature is flagged as an anomaly. Moreover, in some embodiments, the compound-perturbation anomaly detection system 100 can use tail probabilities to determine if a given feature (e.g., a data point) lies in the extreme tails of a multi-dimensional distribution.

From comparing the features 604 with the expected distributions, the compound-perturbation anomaly detection system 100 can generate a plurality of anomaly scores. An anomaly score (or compound activity score) can include a measure of deviation (from a null distribution or other state), activity, or interaction between two variables. Thus, an anomaly score (or compound activity score) can indicate a measure of interaction or activity between a compound and another perturbation (e.g., a compound and a gene).

For instance, the compound-perturbation anomaly detection system 100 can calculate a Z-score for a new data point (e.g., an incoming sample point from the query compound). In particular, the compound-perturbation anomaly detection system 100 can calculate the Z-score by taking the data point (e.g., the given feature corresponding to the query compound), subtracting the mean of the multi-dimensional distribution to get a first result, and dividing the first result by the standard deviation of the multi-dimensional distribution to get the Z-score. If the Z-score exceeds a certain threshold, then the incoming sample data point is considered an anomaly. Moreover, the compound-perturbation anomaly detection system 100 can translate the Z-score to an anomaly score 612. For instance, a Z-score greater than 3 or less than-3 can indicate an anomalous gene-compound relationship, and the compound-perturbation anomaly detection system 100 can translate the Z-score to 0.75. Accordingly, the compound-perturbation anomaly detection system 100 can utilize one or more mapping techniques to go from a Z-score to an anomaly score.

As mentioned previously, the compound-perturbation anomaly detection system 100 can utilize a variety of anomaly detection models. Although the foregoing examples describes a particular approach that utilizes a multi-dimensional distribution (e.g., Gaussian Mixture Model), the compound-perturbation anomaly detection system 100 can utilize different anomaly detection models, including clustering anomaly detection models, machine learning anomaly detection models, etc.

In one or more embodiments, the compound-perturbation anomaly detection system 100 can aggregate the plurality of anomaly scores (e.g., for each of the features 604 of the query compound) to create a combined anomaly score for the query gene and the query compound. In some embodiments, the compound-perturbation anomaly detection system 100 can average the plurality of anomaly scores or use any combination method to create a final anomaly score.

As shown, the compound-perturbation anomaly detection system 100 generates the anomaly score 612. Specifically, the anomaly score 612 shows a score of 0.9 for the query gene interacting with the query compound. In some embodiments, the anomaly score of 0.9 indicates a high likelihood of an anomalous relationship (e.g., an outlier) of the query gene interacting with a query compound. Moreover, in some embodiments, anomaly detection is a relatively rare event, thus, FIG. 6 shows an instance of the compound-perturbation anomaly detection system 100 comparing the features 604 of a query gene and a query compound with expected background distributions for the query gene to identify an anomalous relationship).

In some embodiments, the compound-perturbation anomaly detection system 100 establishes an anomaly score threshold. Specifically, the compound-perturbation anomaly detection system 100 utilizes an anomaly threshold of 0.75. For instance, since the anomaly score 612 shows a score of 0.9, the anomaly score 612 satisfies the established anomaly score threshold.

In some embodiments, the query 603 contains a plurality of query genes and a plurality of query compounds. Specifically, the compound-perturbation anomaly detection system 100 can generate an anomaly score for each of the query genes for each of the query compounds. In doing so, the client device 600 can efficiently identify a desired compound for targeting one or more desired genes.

In some embodiments, the compound-perturbation anomaly detection system 100 can determine to initiate compound exploration programs based on the anomaly score 612. In other words, the above discussed FIGS. 1-6 are implemented/utilized by one or more computing devices to perform compound exploration programs (e.g., drug discovery processes). The compound exploration programs can include industrial program generation (IPG) and industrialized compound generation (ICG). For instance, industrial program generation (IPG) includes (i) a hit selection (e.g., a hit of the anomalous relationship between the gene and the compound) to identify statistically strong connections in a biological map to patient-informed phenotypes, (ii) phenomic confirmation (e.g., promising actives are confirmed by automated similarity and concentration-response analytics), (iii) Trekseq confirmation (e.g., compound and gene relationships are confirmed with transcriptomics in the map background), and (iv) Structure-Activity Relationship (SAR) confidence (e.g., actives that behave as a series are identified, and an automated recommendation for expansion is identified).

ICG applies to steps subsequent to IPG. Further, in some embodiments ICG includes rapidly searching and expanding from potential hit series in the chemical space (e.g., identified at the IPG stage) and testing the potential hits with various analytical tests (e.g., SAR screens). Accordingly, in some embodiments the compound-perturbation anomaly detection system 100 can initiate IPG and/or ICG in response to generating the anomaly score 612 for a gene-compound relationship.

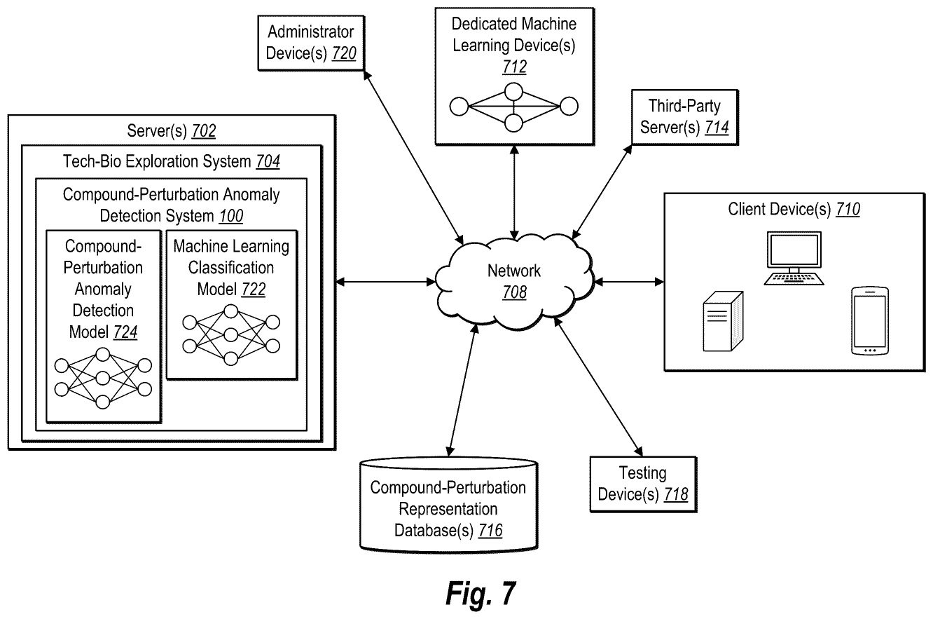

Additional detail regarding the compound-perturbation anomaly detection system 100 will now be provided with reference to the figures. In particular, FIG. 7 illustrates a schematic diagram of a system environment in which the compound-perturbation anomaly detection system 100 can operate in accordance with one or more embodiments.

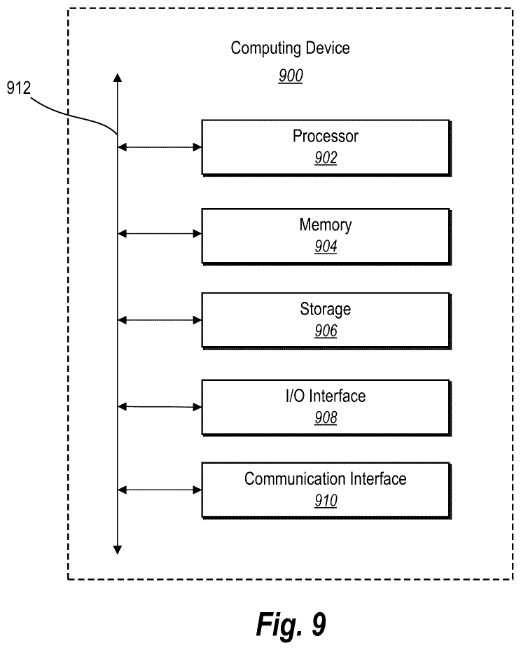

As shown in FIG. 7, the environment includes server(s) 702 (which includes a tech-bio exploration system 704 and the compound-perturbation anomaly detection system 100), a network 708, client device(s) 710, third-party server(s) 714, testing device(s) 718, administrator device(s) 720, gene-compound representation database(s) 716, and dedicated machine learning device(s) 712. As further illustrated in FIG. 7, the various computing devices within the environment can communicate via the network 708. Although FIG. 7 illustrates the compound-perturbation anomaly detection system 100 being implemented by a particular component and/or device within the environment, the compound-perturbation anomaly detection system 100 can be implemented, in whole or in part, by other computing devices and/or components in the environment (e.g., the administrator device(s) 720, the client device(s) 710). Additional description regarding the illustrated computing devices is provided with respect to FIG. 9 below.

As shown in FIG. 7, the server(s) 702 (e.g., one or more local servers operated by a particular entity) can include the tech-bio exploration system 704. In some embodiments, the tech-bio exploration system 704 can determine, store, generate, and/or display tech-bio information including maps of biology, biology experiments from various sources, and/or machine learning tech-bio predictions. For instance, the tech-bio exploration system 704 can analyze data signals corresponding to various treatments or interventions (e.g., compounds or biologics) and the corresponding relationships in genetics, protenomics, phenomics (i.e., cellular phenotypes), and invivomics (e.g., expressions or results within a living animal).

For instance, the tech-bio exploration system 704 can generate and access experimental results corresponding to gene sequences, protein shapes/folding, protein/compound interactions, phenotypes resulting from various interventions or perturbations (e.g., gene knockout sequences or compound treatments), and/or invivo experimentation on various treatments in living animals. By analyzing these signals (e.g., utilizing various machine learning models), the tech-bio exploration system 704 can generate or determine a variety of predictions and inter-relationships for improving treatments/interventions.

To illustrate, the tech-bio exploration system 704 can generate maps of biology indicating biological inter-relationships or similarities between these various input signals to discover potential new treatments. For example, the tech-bio exploration system 704 can utilize machine learning and/or maps of biology to identify a similarity between a first gene associated with disease treatment and a second gene previously unassociated with the disease based on a similarity in resulting phenotypes from gene knockout experiments. The tech-bio exploration system 704 can then identify new treatments based on the gene similarity (e.g., by targeting compounds the impact the second gene). Similarly, the tech-bio exploration system 704 can analyze signals from a variety of sources (e.g., protein interactions, or invivo experiments) to predict efficacious treatments based on various levels of biological data.

The tech-bio exploration system 704 can generate GUIs comprising dynamic user interface elements to convey tech-bio information and receive user input for intelligently exploring tech-bio information. Indeed, as mentioned above, the tech-bio exploration system 704 can generate GUIs displaying different maps of biology that intuitively and efficiently express complex interactions between different biological systems for identifying improved treatment solutions. Furthermore, the tech-bio exploration system 704 can also electronically communicate tech-bio information between various computing devices.

As shown in FIG. 7, the tech-bio exploration system 704 can include a system that facilitates various models or algorithms for generating maps of biology (e.g., maps or visualizations illustrating similarities or relationships between genes, proteins, diseases, compounds, and/or treatments) and discovering new treatment options over one or more networks. For example, the tech-bio exploration system 704 collects, manages, and transmits data across a variety of different entities, accounts, and devices. In some cases, the tech-bio exploration system 704 is a network system that facilitates access to (and analysis of) tech-bio information within a centralized operating system. Indeed, the tech-bio exploration system 704 can link data from different network-based research institutions to generate and analyze maps of biology.

As shown in FIG. 7, the tech-bio exploration system 704 can include a system that comprises the compound-perturbation anomaly detection system 100 that generates gene-compound interaction predictions to train the machine learning classification model 722, selects a set of target features from the gene-compound interaction predictions, and further trains a gene-compound anomaly detection model to identify outlier gene-compound relationships. For example, the compound-perturbation anomaly detection system 100 can train the gene-compound anomaly detection model 724 to generate/identify an anomalous relationship between a gene and a compound in response to receiving a query that includes a query gene and a query compound. In other words, the compound-perturbation anomaly detection system 100 can determine an anomalous relationship for genes and compounds with no prior interaction data.

As used herein, the term “machine learning model” includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques (e.g., supervised or unsupervised learning) to improve in accuracy and/or effectiveness. Example machine learning models include various types of decision trees, support vector machines, Bayesian networks, random forest models, or neural networks (e.g., deep neural networks, generative adversarial neural networks, convolutional neural networks, recurrent neural networks, or diffusion neural networks). Similarly, the term “machine learning data” refers to information, data, or files generated or utilized by a machine learning model. Machine learning data can include training data, machine learning parameters, or embeddings/predictions generated by a machine learning model.

As also illustrated in FIG. 7, the environment includes the client device(s) 710. For example, the client device(s) 710 may include, but is not limited to, a mobile device (e.g., smartphone, tablet) or other type of computing device, including those explained below with reference to FIG. 9. Additionally, the client device(s) 710 can include a computing device associated with (and/or operated by) user accounts for the tech-bio exploration system 704. Moreover, the environment can include various numbers of client devices that communicate and/or interact with the tech-bio exploration system 704 and/or the compound-perturbation anomaly detection system 100.

Furthermore, in one or more implementations, the client device(s) 710 includes a client application. The client application can include instructions that (upon execution) cause the client device(s) 710 to perform various actions. For example, a user of a user account can interact with the client application on the client device(s) 710 to access tech-bio information, generate causal predictions, generate rating metrics, generate program ratings, initiate a request for a machine learning data set, initiate training of a machine learning model utilizing a machine learning data set, and/or generate GUIs comprising a machine learning data set, machine learning predictions/results, and/or machine learning efficacy.

As further shown in FIG. 7, the environment includes the network 708. As mentioned above, the network 708 can enable communication between components of the environment. In one or more embodiments, the network 708 may include a suitable network and may communicate using a various number of communication platforms and technologies suitable for transmitting data and/or communication signals, examples of which are described with reference to FIG. 9. Furthermore, although FIG. 7 illustrates computing devices communicating via the network 708, the various components of the environment can communicate and/or interact via other methods (e.g., communicate directly).

As mentioned previously, in one or more implementations, the compound-perturbation anomaly detection system 100 generates and accesses machine learning objects, such as results from biological assays. As shown, in FIG. 7, the compound-perturbation anomaly detection system 100 can communicate with testing device(s) 718 to obtain and then store this information. For example, the tech-bio exploration system 704 can interact with the testing device(s) 718 that include intelligent robotic devices and camera devices for generating and capturing digital images of cellular phenotypes resulting from different perturbations (e.g., genetic knockouts or compound treatments of stem cells) and sequencing machines. Similarly, the testing device(s) can include camera devices and/or other sensors (e.g., heat or motion sensors) capturing real-time information from animals as part of invivo experimentation. The tech-bio exploration system 704 can also interact with a variety of other testing device(s) such as devices for determining, generating, or extracting gene sequences or protein information.

As shown in FIG. 7, the environment also includes a variety of computing devices (i.e., digital repository platforms) capable of storing machine learning data objects. For instance, the compound-perturbation anomaly detection system 100 can store gene perturbation embeddings, clinical outcome predictions, contribution values, and causal predictions on digital repository platforms for later analysis to determine whether to initiate one or more compound exploration programs (e.g., ICG or IPG). As used herein, the term digital repository platform includes a storage device or set of storage devices (e.g., for storing digital files corresponding to machine learning data sets). In particular, a digital repository platform can include a set of storage devices at a particular location or controlled by a particular entity. Thus, for example, a digital repository platform can include a cloud service (e.g., Amazon Web Services), a local server, or a third-party server.

For example, with regard to the server(s) 702, local servers operating the tech-bio exploration system 704 can store machine learning data objects on various servers distributed geographically across different parts of the country or world. Further, the compound-perturbation anomaly detection system 100 can interact with third-party server(s) 714 (e.g., servers operated and owned by separate entities, such as a coordinating partner with its own biological data). The compound-perturbation anomaly detection system 100 can collaborate with third parties to generate machine learning data sets from machine learning data objects retained on the third-party server(s) 714. In addition, the compound-perturbation anomaly detection system 100 can also interact with dedicated machine learning device(s) 712. For example, the dedicated machine learning device(s) 712 can include computing devices or virtual machines dedicated to training or implementing large-scale machine learning models. In some implementations, the compound-perturbation anomaly detection system 100 can also store machine learning data objects on the dedicated machine learning device(s) 712. For instance, the dedicated machine learning device(s) 712 can include a first classification model for a first gene and a second classification model for a second gene, each trained separately on data specific to the first gene and the second gene, respectively.

As shown in FIG. 7, the environment also includes administrator device(s) 720. For example, the compound-perturbation anomaly detection system 100 can utilize the administrator device(s) 720 to control various functions or operations in scheduling or implementing assays, training or implementing machine learning models, receiving and responding to requests, and/or managing a compound/drug discovery pipeline. To illustrate, the administrator device(s) 720 can identify assays, set up machine learning processes, determine a framework or pipeline for analyzing machine learning models, selecting storage locations in particular digital repository platforms for digital files, and/or determine access permissions to particular digital information or for initiating certain downstream programs (e.g., IPG and ICG).

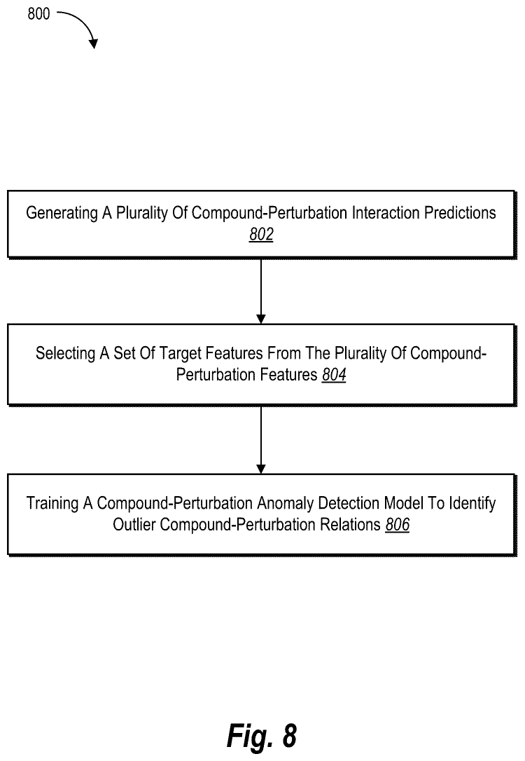

FIGS. 1-7, the corresponding text, and the examples provide a number of different systems, methods, and non-transitory computer readable media for identifying an outlier gene-compound relationship using a compound-perturbation anomaly detection model. In addition to the foregoing, embodiments can also be described in terms of flowcharts comprising acts for accomplishing a particular result. For example, FIG. 8 illustrates a flowchart of an example sequence of acts in accordance with one or more embodiments.

While FIG. 8 illustrates acts according to some embodiments, alternative embodiments may omit, add to, reorder, and/or modify any of the acts shown in FIG. 8. The acts of FIG. 8 can be performed as part of a method (e.g., a computer-implemented method). Alternatively, a non-transitory computer readable medium can comprise instructions, that when executed by one or more processors (e.g., at least one processor), cause a computing device to perform the acts of FIG. 8. In still further embodiments, a system can perform the acts of FIG. 8. Additionally, the acts described herein may be repeated or performed in parallel with one another or in parallel with different instances of the same or other similar acts.

FIG. 8 illustrates an example series of acts 800 for training a compound-perturbation anomaly detection model to identify outlier gene-compound relations in accordance with one or more embodiments. The series of acts 800 can include an act 802 of generating a plurality of compound-perturbation interaction predictions, an act 804 of selecting a sets of target features from the plurality of compound-perturbation features, and an act 806 of training a compound-perturbation anomaly detection model to identify outlier gene-compound relations. Specifically, the series of acts 800 can include acts 802-806 of generating, utilizing a machine learning classification model trained utilizing a plurality of compound-perturbation features, a plurality of compound-perturbation interaction predictions; selecting, utilizing an explainability model, a set of target features from the plurality of compound-perturbation features by determining contribution values for the plurality of compound-perturbation features in generating the plurality of compound-perturbation interaction predictions of the machine learning classification model; and training a compound-perturbation anomaly detection model to identify outlier compound-perturbation relationships from the set of target features.

For example, in one or more embodiments, the series of acts 800 includes generating the plurality of compound-perturbation interaction predictions utilizing at least one of: phenomic similarity measures, efficacy projection data for compounds and target genes, cell count data, or delta ratios indicating a similarity between a compound and a gene relative to additional genes.

In addition, in one or more implementations, the series of acts 800 includes training the machine learning classification model by generating, utilizing the machine learning classification model, the plurality of compound-perturbation interaction predictions utilizing the plurality of compound-perturbation features; comparing the plurality of compound-perturbation interaction predictions with observed gene-compound interactions to determine a measure of loss; and modifying parameters of the machine learning classification model based on the measure of loss.

Further, in some implementations, the series of acts 800 includes training the machine learning classification model utilizing the plurality of compound-perturbation features by determining a first measure of interaction for a gene and a compound at a first concentration; determining a second measure of interaction for the gene and the compound at a second concentration; and generating a rolling window of interaction measures utilizing the first measure of interaction for the compound at the first concentration and the second measure of interaction for the compound at the second concentration.

In one or more implementations, the series of acts 800 includes utilizing the rolling window of the interaction measures as the plurality of compound-perturbation features to generate the plurality of compound-perturbation interaction predictions. Moreover, in one or more implementations, the series of acts 800 includes generating a ranked list of features based on the contribution values for the plurality of compound-perturbation features in generating the plurality of compound-perturbation interaction predictions of the machine learning classification model.

In addition, in some implementations, the series of acts 800 includes identifying a first subset of the set of target features that corresponds to a first gene; and generating, utilizing a probabilistic anomaly detection model, a first multi-dimensional distribution for detecting one or more anomalies based on the first subset of the set of target features. In one or more implementations, the series of acts 800 includes identifying a second subset of the set of target features that corresponds to a second gene; and generating, utilizing the probabilistic anomaly detection model, a second multi-dimensional distribution for detecting one or more anomalies based on the second subset of the set of target features.

In one or more implementations, the series of acts 800 includes receiving a query from a client device, the query comprising a query compound and a query gene; and generating, utilizing the compound-perturbation anomaly detection model, an anomaly score for the query compound and the query gene by comparing features of the query compound and the query gene to a multi-dimensional distribution determined by the compound-perturbation anomaly detection model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 9 illustrates a block diagram of an example computing device 900 that may be configured to perform one or more of the processes described above. One will appreciate that one or more computing devices, such as the computing device 900 may represent the computing devices described above. In one or more embodiments, the computing device 900 may be a mobile device (e.g., a mobile telephone, a smartphone, a PDA, a tablet, a laptop, a camera, a tracker, a watch, a wearable device, etc.). In some embodiments, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, the storage device 906 can include a non-transitory storage medium described above. The storage device 906 may include a hard disk drive (HDD), flash memory, a Universal Serial Bus (USB) drive or a combination these or other storage devices.

As shown, the computing device 900 includes one or more I/O interfaces 908, which are provided to allow a user to provide input to (such as user strokes), receive output from, and otherwise transfer data to and from the computing device 900. These I/O interfaces 908 may include a mouse, keypad or a keyboard, a touch screen, camera, optical scanner, network interface, modem, other known I/O devices or a combination of such I/O interfaces 908. The touch screen may be activated with a stylus or a finger.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can include hardware, software, or both that connects components of computing device 900 to each other.

In one or more implementations, various computing devices can communicate over a computer network. This disclosure contemplates any suitable network. As an example, and not by way of limitation, one or more portions of a network may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these.

In particular embodiments, the computing device 900 can include a client device that includes a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device one or more Hyper Text Markup Language (“HTML”) files responsive to the HTTP request. The client device may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the tech-bio exploration system 704 may include a variety of servers, sub-systems, programs, modules, logs, and data stores. In particular embodiments, the tech-bio exploration system 704 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The tech-bio exploration system 704 may also include suitable components such as network interfaces, security mechanisms, load balancers, failover servers, management-and-network-operations consoles, other suitable components, or any suitable combination thereof. In particular embodiments, the tech-bio exploration system 704 may include one or more user-profile stores for storing user profiles and/or account information for credit accounts, secured accounts, secondary accounts, and other affiliated financial networking system accounts. A user profile may include, for example, biographic information, demographic information, financial information, behavioral information, social information, or other types of descriptive information, such as interests, affinities, or location.

The web server may include a mail server or other messaging functionality for receiving and routing messages between the tech-bio exploration system 704 and one or more client devices. An action logger may be used to receive communications from a web server about a user's actions on or off the tech-bio exploration system 704. In conjunction with the action log, a third-party-content-object log may be maintained of user exposures to third-party-content objects. A notification controller may provide information regarding content objects to a client device. Information may be pushed to a client device as notifications, or information may be pulled from a client device responsive to a request received from the client device. Authorization servers may be used to enforce one or more privacy settings of the users of the tech-bio exploration system 704. A privacy setting of a user determines how particular information associated with a user can be shared. The authorization server may allow users to opt in to or opt out of having their actions logged by the tech-bio exploration system 704 or shared with other systems, such as, for example, by setting appropriate privacy settings. Third-party-content-object stores may be used to store content objects received from third parties. Location stores may be used for storing location information received from a client device associated with users.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, utilizing a machine learning classification model trained utilizing a plurality of compound-perturbation features, a plurality of compound-perturbation interaction predictions;
selecting, utilizing an explainability model, a set of target features from the plurality of compound-perturbation features by determining contribution values for the plurality of compound-perturbation features in generating the plurality of compound-perturbation interaction predictions of the machine learning classification model; and
training a compound-perturbation anomaly detection model to identify outlier compound-perturbation relationships from the set of target features.

2. The computer-implemented method of claim 1, wherein generating the plurality of compound-perturbation interaction predictions utilizing the plurality of compound-perturbation features comprises generating the plurality of compound-perturbation interaction predictions utilizing at least one of: phenomic similarity measures, efficacy projection data for compounds and target genes, cell count data, or delta ratios indicating a similarity between a compound and a gene relative to additional genes.

3. The computer-implemented method of claim 1, further comprising training the machine learning classification model by:
generating, utilizing the machine learning classification model, the plurality of compound-perturbation interaction predictions utilizing the plurality of gene-compound features;
comparing the plurality of compound-perturbation interaction predictions with observed gene-compound interactions to determine a measure of loss; and
modifying parameters of the machine learning classification model based on the measure of loss.

4. The computer-implemented method of claim 1, further comprising training the machine learning classification model utilizing the plurality of compound-perturbation features by:
determining a first measure of interaction for a gene and a compound at a first concentration;
determining a second measure of interaction for the gene and the compound at a second concentration; and
generating a rolling window of interaction measures utilizing the first measure of interaction for the compound at the first concentration and the second measure of interaction for the compound at the second concentration.

5. The computer-implemented method of claim 4, further comprising utilizing the rolling window of the interaction measures as the plurality of compound-perturbation features to generate the plurality of compound-perturbation interaction predictions.

6. The computer-implemented method of claim 1, wherein selecting the set of target features from the plurality of compound-perturbation features further comprises generating a ranked list of features based on the contribution values for the plurality of compound-perturbation features in generating the plurality of compound-perturbation interaction predictions of the machine learning classification model.

7. The computer-implemented method of claim 1, wherein training the compound-perturbation anomaly detection model further comprises:
identifying a first subset of the set of target features that corresponds to a first gene; and
generating, utilizing a probabilistic anomaly detection model, a first multi-dimensional distribution for detecting one or more anomalies based on the first subset of the set of target features.

8. The computer-implemented method of claim 7, further comprising:
identifying a second subset of the set of target features that corresponds to a second gene; and
generating, utilizing the probabilistic anomaly detection model, a second multi-dimensional distribution for detecting one or more anomalies based on the second subset of the set of target features.

9. The computer-implemented method of claim 1, further comprising:
receiving a query from a client device, the query comprising a query compound and a query gene; and
generating, utilizing the compound-perturbation anomaly detection model, an anomaly score for the query compound and the query gene by comparing features of the query compound and the query gene to a multi-dimensional distribution determined by the compound-perturbation anomaly detection model.

10. A system comprising:
at least one processor; and
at least one non-transitory computer-readable storage medium storing instructions that, when executed by the at least one processor, cause the system to:
generate, utilizing a machine learning classification model trained utilizing a plurality of compound-perturbation features, a plurality of compound-perturbation interaction predictions;
select, utilizing an explainability model, a set of target features from the plurality of compound-perturbation features by determining contribution values for the plurality of compound-perturbation features in generating the plurality of compound-perturbation interaction predictions of the machine learning classification model; and
train a compound-perturbation anomaly detection model to identify outlier compound-perturbation relationships from the set of target features.

11. The system of claim 10, further comprising instructions that, when executed by the at least one processor, cause the system to generate the plurality of compound-perturbation interaction predictions utilizing the plurality of compound-perturbation features by generating the plurality of compound-perturbation interaction predictions utilizing at least one of: phenomic similarity measures, efficacy projection data for compounds and target genes, cell count data, or delta ratios indicating a similarity between a compound and a gene relative to additional genes.

12. The system of claim 10, further comprising instructions that, when executed by the at least one processor, cause the system to train the machine learning classification model by:
generating, utilizing the machine learning classification model, the plurality of compound-perturbation interaction predictions utilizing the plurality of compound-perturbation features;
comparing the plurality of compound-perturbation interaction predictions with observed gene-compound interactions to determine a measure of loss; and
modifying parameters of the machine learning classification model based on the measure of loss.

13. The system of claim 10, further comprising instructions that, when executed by the at least one processor, cause the system to train the machine learning classification model utilizing the plurality of compound-perturbation features by:
determining a first measure of interaction for a gene and a compound at a first concentration;
determining a second measure of interaction for the gene and the compound at a second concentration; and
generating a rolling window of interaction measures utilizing the first measure of interaction for the compound at the first concentration and the second measure of interaction for the compound at the second concentration.

14. The system of claim 13, further comprising instructions that, when executed by the at least one processor, cause the system to utilize the rolling window of the interaction measures as the plurality of compound-perturbation features to generate the plurality of compound-perturbation interaction predictions.

15. The system of claim 10, further comprising instructions that, when executed by the at least one processor, cause the system to train the compound-perturbation anomaly detection model by:
identifying a first subset of the set of target features that corresponds to a first gene; and
generating, utilizing a probabilistic anomaly detection model, a multi-dimensional distribution for detecting one or more anomalies based on the first subset of the set of target features.

16. A non-transitory computer-readable medium storing instructions that, when executed by at least one processor, cause a computing device to:
generate, utilizing a machine learning classification model trained utilizing a plurality of compound-perturbation features, a plurality of compound-perturbation interaction predictions;
select, utilizing an explainability model, a set of target features from the plurality of compound-perturbation features by determining contribution values for the plurality of compound-perturbation features in generating the plurality of compound-perturbation interaction predictions of the machine learning classification model; and
train a compound-perturbation anomaly detection model to identify outlier compound-perturbation relationships from the set of target features.

17. The non-transitory computer-readable medium of claim 16, further comprising instructions that, when executed by the at least one processor, cause the computing device to generate the plurality of compound-perturbation interaction predictions utilizing at least one of: phenomic similarity measures, efficacy projection data for compounds and target genes, cell count data, or delta ratios indicating a similarity between a compound and a gene relative to additional genes.

18. The non-transitory computer-readable medium of claim 16, further comprising instructions that, when executed by the at least one processor, cause the computing device to train the compound-perturbation anomaly detection model by:
identifying a first subset of the set of target features that corresponds to a first gene; and
generating, utilizing a probabilistic anomaly detection model, a first multi-dimensional distribution for detecting one or more anomalies based on the first subset of the set of target features.

19. The non-transitory computer-readable medium of claim 18, further comprising instructions that, when executed by the at least one processor, cause the computing device to:
identify a second subset of the set of target features that corresponds to a second gene; and
generate, utilizing the probabilistic anomaly detection model, a second multi-dimensional distribution for detecting one or more anomalies based on the second subset of the set of target features.

20. The non-transitory computer-readable medium of claim 16, further comprising instructions that, when executed by the at least one processor, cause the computing device to:
receive a query from a client device, the query comprising a query compound and a query gene; and
generate, utilizing the compound-perturbation anomaly detection model, an anomaly score for the query compound and the query gene by comparing features of the query compound and the query gene to a multi-dimensional distribution determined by the compound-perturbation anomaly detection model.
